(19) United States
(12) Patent Application Publication
(10) Pub. No.: US 2025/0062319 A1
(43) Pub. Date: Feb. 20, 2025

(54) METHOD OF PRE-FORMING ANODE PARTICLES HAVING TAILORED SOLID ELECTROLYTE INTERPHASE COMPOSITION

(71) Applicant: GM Global Technology Operations LLC, Detroit, MI (US)

(72) Inventors: Jeffrey David Cain, Royal Oak, MI (US); Nicholas Paul William Pieczonka, Windsor (CA); Sayed Youssef Sayed Nagy, Troy, MI (US); Zachary Hood, Bolingbrook, IL (US); Shiba Adhikari, Lemont, IL (US)

(21) Appl. No.: 18/449,261

(22) Filed: Aug. 14, 2023

(51) Int. Cl. H01M 4/36; C25D 7/00; C25D 9/02; C25D 9/04; H01M 4/04; H01M 4/62; H01M 10/0525; H01M 10/42

(52) U.S. Cl. CPC H01M 4/366; C25D 7/006; C25D 9/02; C25D 9/04; H01M 4/0404; H01M 4/0452; H01M 4/62; H01M 10/0525; H01M 10/4235; H01M 2004/021; H01M 2004/027

(57) ABSTRACT

A method is provided for pre-forming anode particles for use in lithium ion batteries. The pre-formed anode particles bear a solid electrolyte of a composition that cannot be formed in situ in the battery. The method includes providing a dispersion of anode precursor particles and an additive not found in the battery in a liquid electrolyte solution. Applying a voltage or current across the dispersion forms the solid electrolyte interphase, on the particles. These particles can be used in an electrode of a lithium ion battery.

The Government has rights in this invention pursuant to STRATEGIC PARTNERSHIP PROJECT AGREEMENT NO. A21190 Between UCHICAGO ARGONNE, LLC AS OPERATOR OF ARGONNE NATIONAL LABORATORY OPERATING UNDER PRIME CONTRACT NO. DE-AC02-06CH11357 FOR THE U. S. DEPARTMENT OF ENERGY and GENERAL MOTORS LLC

### INTRODUCTION

The subject disclosure relates to a method of forming particles useful in anodes in lithium ion batteries.

Advanced energy storage devices and systems are in demand to satisfy energy and/or power requirements for a variety of products, including automotive products such as start-stop systems (e.g., 12V start-stop systems), battery-assisted systems, Hybrid Electric Vehicles (“HEVs”), and Electric Vehicles (“EVs”).

Typical lithium-ion batteries include at least two electrodes and an electrolyte and/or separator. One of the two electrodes serves as a positive electrode (a cathode) and the other electrode serves as a negative electrode (an anode). A separator and/or electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte, the solid-state electrolyte may physically separate the electrodes so that a distinct separator is not required.

Conventional rechargeable lithium-ion batteries operate by reversibly passing lithium ions back and forth between the negative electrode and the positive electrode. For example, lithium ions may move from the positive electrode to the negative electrode during charging of the battery, and in the opposite direction when discharging the battery. Such lithium-ion batteries can reversibly supply power to an associated load device on demand. More specifically, electrical power can be supplied to a load device by the lithium-ion battery until the lithium content of the negative electrode is effectively depleted. The battery may then be recharged by passing a suitable direct electrical current in the opposite direction between the electrodes.

During discharge, the negative electrode may contain a comparatively high concentration of lithium (e.g., intercalated lithium), which is oxidized into lithium ions and electrons. Lithium ions may travel from the negative electrode to the positive electrode, for example, through the ionically conductive electrolyte solution contained within the pores of an interposed porous separator. Concurrently, electrons pass through an external circuit from the negative electrode to the positive electrode. Such lithium ions may be assimilated into the material of the positive electrode by an electrochemical reduction reaction. The battery may be recharged or regenerated after a partial or full discharge of its available capacity by an external power source, which reverses the electrochemical reactions that transpired during discharge.

During an initial cycle or the first few cycles of the battery a solid electrolyte interphase (SEI) forms on the negative electrode by decomposition product of electrolytes. The SEI is ion conductive but electron-insulating. The SEI is insoluble in the electrolyte of the battery and can increase the impedance and resistance of the battery. However, the SEI can also prevent further electrolyte decomposition. Thus, the SEI can impact cyclability, rate capacity, irreversible capacity loss and the like in lithium ion batteries.

### SUMMARY

In one exemplary embodiment, disclosed is a method of pre-forming anode particles bearing a solid electrolyte interphase, the anode particles being for use in an anode of a lithium ion battery, where the lithium ion battery includes the anode, an anode current collector, a cathode, a cathode current collector, an optional separator, and a battery electrolyte. The method includes providing a dispersion in a vessel configured for electrochemical reactions, wherein the dispersion has anode precursor particles, a first liquid electrolyte solution, and an additive not found in the lithium ion battery. A voltage or a current is applied across the dispersion to form the anode particles bearing the solid electrolyte interphase. The anode particles bearing the solid electrolyte interphase can be recovered from the dispersion.

In addition to the one or more features described herein, the additive can be present in the dispersion before applying the voltage or the current. Alternatively, the additive can be added to the dispersion during the application of the voltage or the current.

In addition to the one or more features described herein, after applying the voltage or the current and during the application of the voltage or the current, an additional additive can be introduced to the dispersion to form a solid electrolyte interphase having a first layer of a first composition and a second layer of a second composition. The step of introducing an additional additive and applying the voltage after introducing the additional additive can be repeated with various additives.

In addition to the one or more features described herein, the anode particles can include silicon, germanium, tin, bismuth, graphite, antimony, silicon oxide, or a combination of two or more thereof.

In addition to the one or more features described herein, the anode particles can have an average particle size of from 50 nanometers to 100 micrometers.

In addition to the one or more features described herein, the solid electrolyte interphase can have a thickness of 1 to 100 nanometers.

In addition to the one or more features described herein, the first liquid electrolyte solution can include a salt in a solvent. The salt an include lithium bis(fluorosulfonyl)imide, lithium bis(trifluoromethanesulfonyl)imide, lithium bis(oxalato) borate, lithium difluorooxalatoborate, or 1,1,2,2-tetra-fluoroethyl-2,2,3,3-tetrafluoropropyl ether. The solvent can include ethylene carbonate, dimethyl carbonate, ethyl methyl carbonate, diethyl carbonate, propylene carbonate, dimethyl sulfoxide, ethyl acetate, gamma butyrolactone, 1,2-dimethoxyethane, or tetraethylene glycol dimethyl ether.

In addition to the one or more features described herein, the additive can include a fluorinated carbonate, a vinylene carbonate, an alkoxy silane, or an alkyl acrylamide.

In addition to the one or more features described herein, the dispersion can include 1 to 25 weight percent of the anode particles, and 0.001 to 10 weight percent of the additive based on total weight of the dispersion.

In addition to the one or more features described herein, the electrochemical reaction vessel can have a conductive shell as a current collector and an electrode including lithium metal.

In addition to the one or more features described herein, the voltage can be applied at a level of +/−10 to +/−7000 millivolts.

In addition to the one or more features described herein, the current can be applied at a level of from +/−0.01 to +/−10 milliamps per square centimeter.

In addition to the one or more features described herein, the solid electrolyte interphase can be a homogeneous composition. Alternatively, the solid electrolyte interphase layer can have a composition that varies along a gradient from a surface of the anode particle to a surface of the solid electrolyte interphase.

In addition to the one or more features described herein, the solid electrolyte interphase can be inorganic, organic, or a combination thereof.

In addition to the one or more features described herein, the method can further include forming a second dispersion having the anode particles bearing the solid electrolyte interphase, and a second liquid electrolyte solution which is different from first liquid electrolyte solution and applying a voltage or a current across the dispersion to form a second layer of solid electrolyte interphase on the anode particles.

In another exemplary embodiment, the method includes forming a slurry having the anode particles bearing the solid electrolyte interphase as disclosed herein, a binder, a conductive component and solvent, applying the slurry to a current collector, drying and optionally curing to form an anode.

In another exemplary embodiment, disclosed herein is lithium ion battery having an anode disposed on an anode current collector, a cathode disposed on a cathode current collector, an optional separator, disposed between the anode and the cathode, and a battery electrolyte. The anode includes anode particles having a pre-formed solid electrolyte interphase of a composition that could not be formed in situ in the battery.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic of an example of a device for performing certain embodiments of the method as disclosed herein;

FIG. 2 is a schematic of an example of an anode particle as can be made by an example of the method disclosed herein with a pre-formed solid electrolyte interphase:

FIG. 3. is a schematic of an example of an anode particle as can be made by an example of the method disclosed herein with a pre-formed solid electrolyte interphase (bilayer SEI); and

FIG. 4 is a schematic of an example electrochemical lithium ion battery.

### DETAILED DESCRIPTION

The following description is merely exemplary in nature and is not intended to limit the present disclosure, its application or uses. It should be understood that throughout the drawings, corresponding reference numerals indicate like or corresponding parts and features.

The method disclosed herein provides the ability to pre-form the SEI on anode particles before formation of the anode and before assembly of the battery. By pre-forming the SEI, the capacity loss in the battery upon initial cycling can be reduced, the first cycle Coulombic efficiency in the battery can be increased, and/or the active lithium loss can be reduced. Moreover, the method enables formation of SEI having compositions that would not be attainable from in-situ formation of the SEI during the initial cycling of the battery.

In accordance with an exemplary embodiment the method disclosed herein provides for making anode particles having a preformed solid electrolyte interphase thereon.

The method includes providing a solid-liquid dispersion in an electrochemical reaction vessel, wherein the solid-liquid dispersion includes anode particles, a first liquid electrolyte solution, and an additive not found in the battery-more particularly, not found in the battery electrolyte. The method includes applying a voltage or a current across the solid-liquid dispersion to form a layer of a solid electrolyte interphase around individual anode particles wherein the solid electrolyte interphase includes the additive or a reaction product of the additive. The method can include separating the anode particles bearing the solid electrolyte interphase layer from the dispersion. The voltage can be from +/−10 to +/−7000, or +/−500 to +/−3000 millivolts. The current density can be from +/−0.01 to +/−10 milliamps per square centimeter.

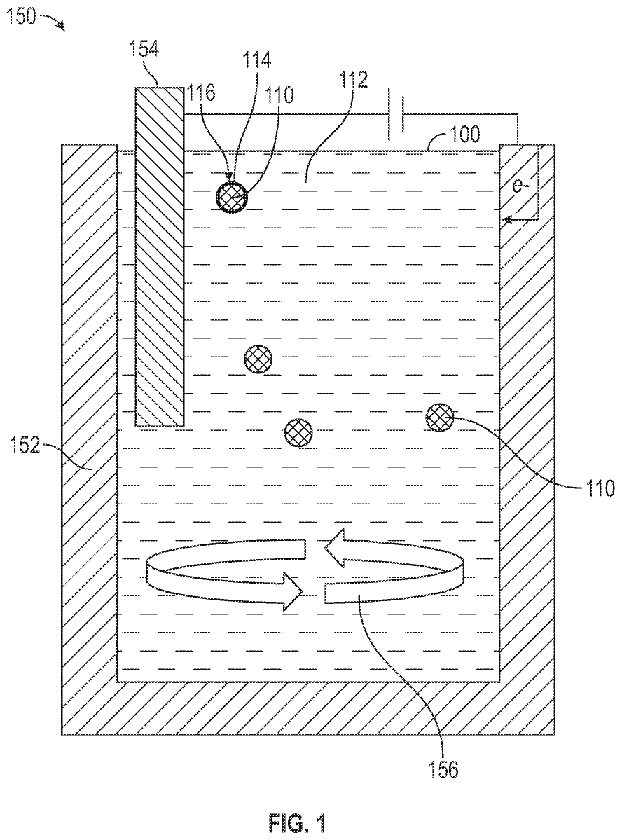

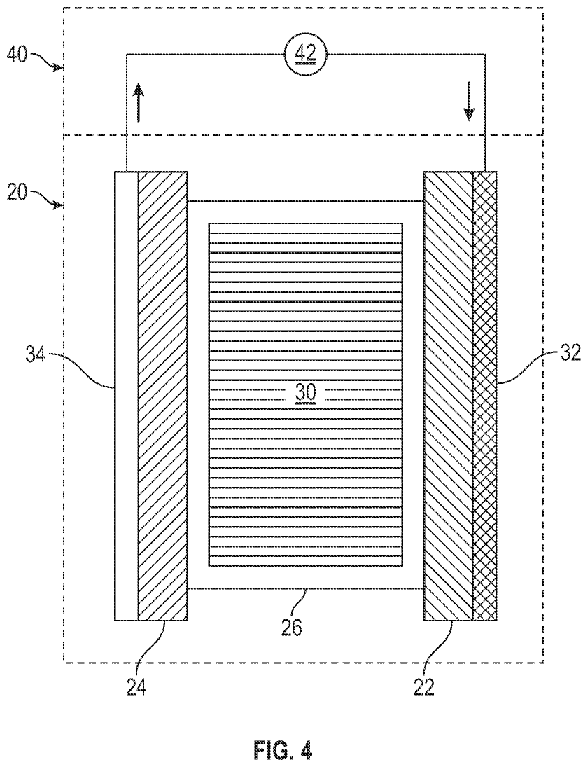

For example, as shown in FIG. 1 includes providing a dispersion 100 of anode particles 110, electrolyte solution 112 including an in a vessel 150. The vessel can include a shell 152. The shell can include conductive material which can serve as a current collector. An electrode 154, such as a can be placed in the electrolyte solution 112 and a voltage or a current applied. If lithiation of the anode particles 110 is desired the electrode 154 can include lithium. An additive is included in the electrolyte solution 112. For example, the additive can be a component that is soluble in the electrolyte solution 112 or can be a component that is dispersed in the electrolyte solution 112. The additive includes chemical components not found in a battery (including an electrolyte of a battery) such as the battery 20 or the electrolyte 30 of the battery 20 of FIG. 4. When a voltage or a current is applied a solid electrolyte interphase is formed on the particle 110. The solid electrolyte interphase will be a product of the electrochemical reaction between electrolyte, the anode particle, and any additives present. The specific composition of the solid electrolyte interphase will be influenced by those components as well as the voltage or current applied. One of the electrodes can include lithium. Having a lithium source enables pre-lithiation of the anode particles. The vessel can include a mixer 156. As an alternative to the vessel 150 as shown which can operate in batch mode, a flow-through vessel could be used for continuous production.

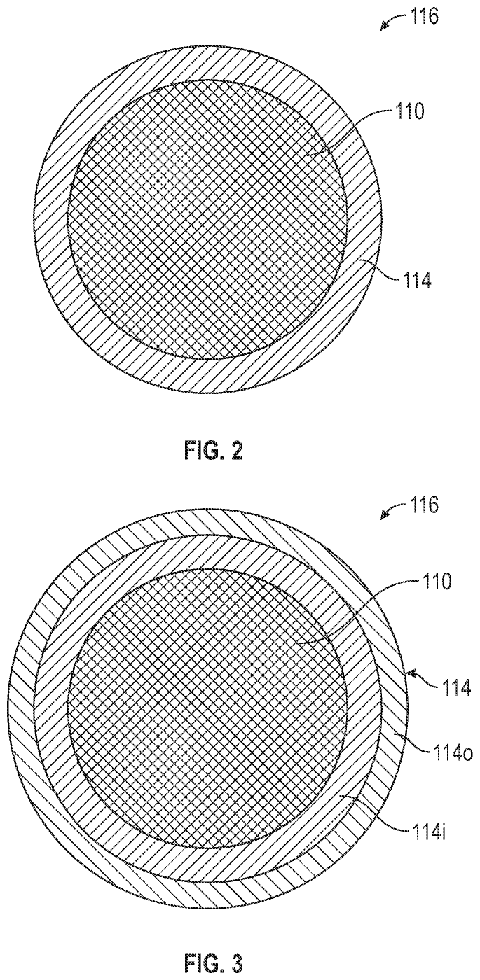

As a voltage or a current is applied across the dispersion 100 a solid electrolyte interphase 114 is formed on the anode particles 110 to form coated particle 116 as shown in FIG. 2.

After forming the coated particles 116 (i.e., the anode particles 110 bearing the SEI 114), the coated particles 116 can be separated from the dispersion 100 for future use. For example, the dispersion 100 can be filtered to separate the coated particle 116 from the electrolyte solution 112. Optionally, the coated particles 116 can be rinsed. As another example, a centrifuge can be used to separate the coated particles 116.

The dispersion 100 can include the anode particles 110 in an amount of from 1 to 25, or 1.5 to 20, or 2 to 10, weight percent based on total weight of the dispersion. The dispersion 100 can include the additive in the electrolyte solution 112 in an amount of 0.001 to 10, or 0.01 to 5, or 0.1 to 3 weight percent based on total weight of the dispersion. The electrolyte solution 112 can make up the remainder of the dispersion 100.

The anode particles can include, for example, silicon, germanium, tin, bismuth, graphite, antimony, silicon oxide, or a combination (e.g., alloy) of two or more thereof. As another example, the anode particles can include a lithium based material including lithium metal and/or lithium alloy. As another example, the anode particles can include lithium accepting materials such as lithium titanium oxide (Li₄Ti₅O₁₂), one or more transition metals (such as tin (Sn)), one or more metal oxides (such as vanadium oxide (V₂O₅), tin oxide (SnO), titanium dioxide (TiO₂)), and/or titanium niobium oxide (TiₓNb_{y}O_{z}, where 0≤x≤2, 0≤y≤24, and 0≤z≤64).

The anode particles can be in the form of beads or pellets. The beads or pellets can have a regular shape, such as a substantially spherical or can have an irregular shape. The beads or pellets can have an average particle size of 50 nanometers (nm) to 100 microns (micrometers), 100 nm to 10 microns, or 200 nm to 5 micron. If the beads or pellets are irregular in shape the aspect ratio of largest to smallest dimension can be less than 2:1. Alternatively, the anode particles can be in the form of platelets or nanowires. Such platelets can have a thickness of from 20 nm up to 10, up to 5, or up to 2 microns with a dimension orthogonal to thickness from 5 to 20 times the thickness. Such nanowires can have a length of 100 nm to 1 micron and an aspect ratio (length to cross sectional dimension orthogonal to length) of 2 to 100. Particle size can be determined using a particle size analyzer, such as, dynamic light scattering or electron microscopy imaging.

The electrolyte solution 112 can have an ionic compound, such as a salt, in a solvent. Examples of such ionic compounds that can be used include lithium bis(fluorosulfonyl)imide, lithium bis(trifluoromethanesulfonyl)imide, lithium bis(oxalato) borate, lithium difluorooxalatoborate, and 1,1,2,2-tetra-fluoroethyl-2,2,3,3-tetrafluoropropyl ether. Examples of the solvent include ethylene carbonate, dimethyl carbonate, ethyl methyl carbonate, diethyl carbonate, propylene carbonate, dimethyl sulfoxide, ethyl acetate, gamma butyrolactone, 1,2-dimethoxyethane, and tetraethylene glycol dimethyl ether.

The additive is selected to provide a composition of the solid electrolyte interphase 114 on the anode particle 110 that cannot be obtained by in-situ formation of a solid electrolyte interphase during operation of a lithium ion battery. The additive, can be for example, a fluorinated carbonate such as fluoroethylene carbonate, or methyl (2,2,2-trifluoroethyl) carbonate: a vinylene carbonate, an alkoxy silane such as tetraethoxysilane or (2-cyanoethyl)triethoxysilane, or an alkyl acrylamide such as dimethylacrylamide. More than one additive can be used. The additives can be added at separate times. For instance, a first additive can be present in the initial dispersion while a second additive can be added at a later time.

The components of the dispersion 110 can be combined and agitated to insure suspension of the anode particles while the voltage or current is applied.

By varying the applied voltage or the applied current over time, adjusting the time when an additive is introduced, using more than one additive, varying the concentration of the additive(s) or a combination thereof, the chemical composition of the solid electrolyte interphase can be controlled. For example, a solid electrolyte interphase can have a gradient in concentration from the position adjacent to the anode particle to the exterior of the solid electrolyte interphase. As another example, a bilayer solid electrolyte interphase can be formed as shown in FIG. 3. The bilayer solid electrolyte interphase 114 has an inner layer 114i and an outer layer 1140 on the anode particle 110 resulting in the coated particle 116.

For example, the additive can be added to the solid-liquid dispersion before applying the voltage. As another example, the additive can be added to the solid-liquid dispersion after initial application of the voltage and during the application of the voltage. As another example, before adding the additive to the soli-liquid dispersion an initial voltage is applied across the combination of the anode particles and liquid electrolyte solution. As another example, after applying the voltage introducing an additional additive is introduced to the solid liquid dispersion and a voltage is applied after introducing the additional additive. The process of adding an additional additive and applying the voltage after introducing the additional additive can be repeated to provide further differentiations to the chemistry in outer portions of the solid electrolyte interphase. If two clearly differentiated bilayers of solid electrolyte interphase are desired the particles can be separated and rinsed after formation of a first solid liquid interphase and then reintroduced into a second electrolyte solution having a different solvent, a different salt, and/or a different additive.

Examples of inorganic solid electrolyte interphase 114 that can be obtained using the method disclosed include lithium carbonate (Li₂CO₃O, lithium fluoride (LiF), Li₂O, and Li₃N. Examples of organic solid electrolyte interphase 114 that can be obtained using the method disclosed include lithium alkyl carbonates, such as lithium ethylene decarbonate.

Batteries can be made having the anode-particles with pre-formed solid electrolyte interphase as described herein. These batteries can then include anode particles with solid electrolyte interphase that could not be formed in situ n the battery. Particularly, the battery can include an anode having anode particles having a pre-formed solid electrolyte interphase disposed on an anode current collector, a cathode disposed on a cathode current collector, an optional separator disposed between the anode and the cathode, and a battery electrolyte. The solid electrolyte interphase can have a composition that could not be formed in situ in the battery.

For example, FIG. 4 shows an exemplary schematic illustration of an electrochemical cell (also referred to as the battery) 20. The battery 20 includes a negative electrode (i.e., anode) 22 disposed on a current collector 32, a positive electrode (i.e., cathode) 24 disposed on a current collector 34, and a separator 26 disposed between the electrodes 22, 24. The separator 26 provides electrical separation (i.e., prevents physical contact) between the electrodes 22, 24. The separator 26 also provides a minimal resistance path for internal passage of lithium ions, and in certain instances, related anions, during cycling of the lithium ions. The battery includes electrolyte 30 shown as present in the separator 26. In certain aspects, the electrolyte can also be present in the anode 22 and cathode 24. In certain variations, the separator 26 may be formed by a solid-state electrolyte 30. The anode current collector 32 and the cathode current collector 34 respectively collect and move free electrons to and from an external circuit 40. For example, an interruptible external circuit 40 and a load device 42 may connect the anode 22 (through the negative electrode current collector 32) and the cathode 24 (through the cathode current collector 34).

In the battery 20, the cathode 24 has a lithium-based positive electroactive material that is capable of undergoing lithium intercalation and deintercalation, alloying and dealloying, or plating and stripping, while functioning as a positive terminal of the capacitor battery 20. In various aspects, the cathode 24 may be defined by a plurality of electroactive material particles (not shown). Such positive electroactive material particles may be disposed in one or more layers so as to define the three-dimensional structure of the cathode 24. In certain variations, as noted above, the cathode 24 may further include the electrolyte 30, for example a plurality of electrolyte particles (not shown).

In various aspects, the cathode 24 may be one of a layered-oxide cathode, a spinel cathode, and a polyanion cathode. For example, layered-oxide cathodes (e.g., rock salt layered oxides) include one or more lithium-based positive electroactive materials selected from LiNixMnyCo1-x-yO2 (where 0≤x≤1 and 0≤y≤1), LiNixMn1-xO2 (where 0≤x≤1), Li1+xMO2 (where M is one of Mn, Ni, Co, and Al and 0≤x≤1) (for example LiCoO2 (LCO), LiNiO2, LiMnO2, LiNi0.5Mn0.5O2, NMC111, NMC523, NMC622, NMC 721, NMC811, NCA). Spinel cathodes comp include rise one or more lithium-based positive electroactive materials selected from LiMn2O4 and LiNi0.5Mn1.5O4. Olivine type cathodes include one or more lithium-based positive electroactive material such as LiV2(PO4)3, LiFePO4, LiCoPO4, and LiMnPO4. Tavorite type cathodes include, for example, LiVPO4F. Borate type cathodes include, for example, one or more of LiFeBO3, LiCoBO3, and LiMnBO3. Silicate type cathodes include, for example, Li2FeSiO4, Li2MnSiO4, and LiMnSiO4F. In still further variations, the cathode 24 may include one or more other positive electroactive materials, such as one or more of dilithium (2,5-dilithiooxy) terephthalate and polyimide. In various aspects, the positive electroactive material may be optionally coated (for example by LiNbO3 and/or Al₂O₃) and/or may be doped (for example by one or more of magnesium (Mg), aluminum (Al), and manganese (Mn)).

The positive electroactive material of the cathode 24 may be optionally intermingled with one or more electrically conductive materials that provide an electron conductive path and/or at least one polymeric binder material that improves the structural integrity of the cathode 24. For example, the positive electroactive material in the cathode 24 may be optionally intermingled with binders such as poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), lithium polyacry late (LiPAA), sodium polyacrylate (NaPAA), sodium alginate, lithium alginate, ethylene propylene diene monomer (EPDM), and combinations thereof. Electrically conductive materials may include carbon-based materials, powder nickel or other metal particles, or a conductive polymer. Carbon-based materials may include, for example, particles of carbon black, graphite, acetylene black (such as KETCHEN™ black or DENKA™ black), carbon fibers and nanotubes, graphene, and the like. Examples of a conductive polymer include polyaniline, polythiophene, polyacetylene, polypyrrole, and the like.

For example, the cathode 24 may include greater than or equal to about 50 wt. % to less than or equal to about 99 wt. %, and in certain aspects, optionally greater than or equal to about 50 wt. % to less than or equal to about 95 wt. %, of the positive electroactive material: greater than or equal to about 0 wt. % to less than or equal to about 30 wt. %, and in certain aspects, optionally greater than or equal to about 2 wt. % to less than or equal to about 5 wt. %, of one or more electrically conductive materials; and greater than or equal to about 0 wt. % to less than or equal to about 20 wt. %, and in certain aspects, optionally greater than or equal to about 2 wt. % to less than or equal to about 5 wt. %, of one or more binders.

In the battery 20, the anode 22 can include the anode particles bearing the pre-formed solid electrolyte interphase as described herein. The anode 22 can further include electrically conductive material such as carbon black, graphene, and/or carbon nanotubes. The anode 22 can further include a binder material such as binders such as poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), lithium polyacrylate (LiPAA), sodium polyacrylate (NaPAA), sodium alginate, lithium alginate, ethylene propylene diene monomer (EPDM), and combinations thereof.

The anode 22 can include greater than or equal to about 50 wt. % to less than or equal to about 99 wt. %, and in certain aspects, optionally greater than or equal to about 50 wt. % to less than or equal to about 95 wt. %, of the anode particles bearing the pre-formed SEI, greater than or equal to about 0 wt. % to less than or equal to about 30 wt %, and in certain aspects, optionally greater than or equal to about 5 wt. % to less than or equal to about 20 wt. %, of one or more electrically conductive materials; and greater than or equal to about 0 wt. % to less than or equal to about 20 wt %, and in certain aspects, optionally greater than or equal to about 5 wt. % to less than or equal to about 15 wt. %, of one or more binders.

The battery electrolyte 30 can include an ionic compound, such as a salt, optionally, in a solvent. Examples of such ionic compounds that can be used include lithium bis(fluorosulfonyl)imide, lithium bis(trifluoromethanesulfonyl)imide, lithium bis(oxalato) borate, lithium difluorooxalatoborate, and 1,1,2,2-tetra-fluoroethyl-2,2,3,3-tetrafluoropropyl ether. Examples of the solvent include ethylene carbonate, dimethyl carbonate, ethyl methyl carbonate, diethyl carbonate, propylene carbonate, dimethyl sulfoxide, ethyl acetate, gamma butyrolactone, 1,2-dimethoxyethane, and tetraethylene glycol dimethyl ether.

In an exemplary embodiment, the battery can have a solid state polymer electrolyte.

The separator 26 can include polymeric separators, such as polypropylene or polyethylene, ceramics, or polymer/ceramic composites.

In an exemplary embodiment, the battery can have a solid state electrolyte/separator such as ceramic, e g . . . a lithium metal oxide. LISICON, pervoskites, sulfide solid electrolyte, or gamets.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of pre-forming anode particles bearing a solid electrolyte interphase, the anode particles being for use in an anode of a lithium ion battery, where the lithium ion battery includes the anode, an anode current collector, a cathode, a cathode current collector, an optional separator, and a battery electrolyte, the method comprising:
providing a dispersion in a vessel configured for electrochemical reactions, wherein the dispersion comprises anode precursor particles and a first liquid electrolyte solution, and the dispersion includes an additive not found in the lithium ion battery,
applying a voltage across the dispersion or applying a current across the dispersion to form the anode particles bearing the solid electrolyte interphase, and
recovering the anode particles bearing the solid electrolyte interphase from the dispersion.

2. The method of claim 1 wherein the additive is present in the dispersion before applying the voltage or the current.

3. The method of claim 1 wherein the additive is added to the dispersion during the application of the voltage or the current.

4. The method of claim 2 wherein after applying the voltage or the current and during the application of the voltage or the current, introducing an additional additive to the dispersion to form a solid electrolyte interphase having a first layer of a first composition and a second layer of a second composition.

5. The method of claim 4 further comprising repeating the step of introducing an additional additive and applying the voltage after introducing the additional additive.

6. The method of claim 1 wherein the anode particles comprise silicon, germanium, tin, bismuth, graphite, antimony, silicon oxide, or a combination of two or more thereof.

7. The method of claim 1 wherein the anode particles have an average particle size of from 50 nanometers to 100 micrometers.

8. The method of claim 1 wherein the solid electrolyte interphase has a thickness of 1 to 100 nanometers.

9. The method of claim 1 wherein the first liquid electrolyte solution comprises a salt in a solvent wherein the salt comprises lithium bis(fluorosulfonyl)imide, lithium bis(trifluoromethanesulfonyl)imide, lithium bis(oxalato) borate, lithium difluorooxalatoborate, or 1,1,2,2-tetra-fluoroethyl-2,2,3,3-tetrafluoropropyl ether and/or the solvent comprises ethylene carbonate, dimethyl carbonate, ethyl methyl carbonate, diethyl carbonate, propylene carbonate, dimethyl sulfoxide, ethyl acetate, gamma butyrolactone, 1,2-dimethoxyethane, or tetraethylene glycol dimethyl ether.

10. The method of claim 1 wherein the additive comprises a fluorinated carbonate, a vinylene carbonate, an alkoxy silane, or an alkyl acrylamide.

11. The method of claim 1 wherein the dispersion comprises 1 to 25 weight percent of the anode particles, and 0.001 to 10 weight percent of the additive based on total weight of the dispersion.

12. The method of claim 1 wherein the electrochemical reaction vessel comprises a conductive shell as a current collector and an electrode comprising lithium metal.

13. The method of claim 1 wherein voltage is applied at a level of +/−10 to +/−7000 millivolts.

14. The method of claim 1 wherein current is applied at a level of from +/−0.01 to +/−10 milliamps per square centimeter.

15. The method of claim 1 wherein the solid electrolyte interphase is a homogeneous composition.

16. The method of claim 1 wherein the solid electrolyte interphase has a composition which varies along a gradient from a surface of the anode particle to a surface of the solid electrolyte interphase.

17. The method of claim 1 wherein the solid electrolyte interphase is inorganic, organic, or a combination thereof.

18. The method of claim 1 further comprising forming a second dispersion comprising the anode particles bearing the solid electrolyte interphase, and a second liquid electrolyte solution which is different from first liquid electrolyte solution and applying a voltage or a current across the dispersion to form a second layer of solid electrolyte interphase on the anode particles.

19. The method of claim 1 comprising forming a slurry comprising the anode particles bearing the solid electrolyte interphase, a binder, a conductive component and solvent, applying the slurry to a current collector, drying and optionally curing to form an anode.

20. A lithium ion battery comprising an anode disposed on an anode current collector, a cathode disposed on a cathode current collector, an optional separator, disposed between the anode and the cathode, and a battery electrolyte, wherein the anode comprises anode particles having a pre-formed solid electrolyte interphase of a composition that could not be formed in situ in the lithium ion battery.
